(19) United States
(12) Patent Application Publication
(10) Pub. No.: US 2022/0405446 A1
(43) Pub. Date: Dec. 22, 2022

(54) HIGH-PRECISION HIGH-FIDELITY REAL-TIME SIMULATION AND BEHAVIOR PREDICTION METHOD AND DEVICE FOR NUCLEAR POWER STATION

(71) Applicant: Shanghai Jiao Tong University, Shanghai (CN)

(72) Inventor: Po HU, Shanghai (CN)

(73) Assignee: Shanghai Jiao Tong University, Shanghai (CN)

(21) Appl. No.: 17/638,189

(22) PCT Filed: Jun. 7, 2021
(86) PCT No.: PCT/CN2021/098564

§ 371 Date: Feb. 25, 2022

(30) Foreign Application Priority Data
Jun. 16, 2020 (CN) 202010548243.4

(51) Int. Cl. G06F 30/27; G21D 3/00

(52) U.S. Cl. CPC G06F 30/27; G21D 3/002; G06F 2119/02

(57) ABSTRACT

A high-precision high-fidelity real-time simulation and behavior prediction method and device for a nuclear power station is provided. The method comprises the following steps: (1) constructing a nuclear power station simulator and a physical nuclear power station based on the same design parameters; (2) operating the nuclear power station simulator and the physical nuclear power station in parallel, and obtaining predicted parameters output by the nuclear power station simulator and operation parameters of the physical nuclear power station in real time; (3) comparing the predicted parameters and the operation parameters representing the same physical quantity one by one, and correcting prediction models in the nuclear power station simulator and input parameters of the prediction models by adopting a large-scale concurrent-parallel parameter search and correction algorithm and an artificial intelligence-based mode recognition and correction algorithm until the predicted parameters reach specified precision; and (4) operating the nuclear power station simulator according to a set operation condition to obtain the predicted parameters, thereby completing a behavior prediction of a physical nuclear power station system.

### TECHNICAL FIELD

The present invention relates to a simulation and behavior prediction method and system for a nuclear power station, and in particular to a high-precision high-fidelity real-time simulation and behavior prediction method and device for a nuclear power station.

### RELATED ART

The existing nuclear power station simulator is mainly based on a professional software such as a thermal-hydraulic system program to establish a calculation model for the main equipments and pipelines of primary and secondary loops of a nuclear power station, as well as a control system. Design parameters of a reactor or technical parameters of an actual reactor are used as input variables, so as to calculate system responses of the nuclear power station under different working conditions, to provide reference and guidance for design optimization and actual control.

Most of the existing nuclear power stations have customized a set of simulation and calculation softwares (simulators) according to their own design characteristics and actual construction status for using as operator training and actual control rehearsal and so on. At present, the simulation and calculation softwares generally adopt a mature and classic professional software well recognized in the industry in the early stage of service of the nuclear power station, and then compiles calculation card of the power station based on station design and operational parameter, and then after initial debugging and verification, it can be officially delivered to a user. Although in the process of use, the relevant parameters of the calculation card can be adjusted according to the specific conditions of the operation of the power station to obtain calculation results of different operating states. Considering that a nuclear power station system is actually a huge modern industrial system with thousands of parameters involved, once it is put into operation, due to the radiation characteristics of the nuclear power station, many parameters can no longer be obtained in real time. Even if some of parameters are obtained, it is not possible to fully deduce the changes of all key parameters relative to initial design parameters. In this way, after running for a period of time, the prediction of the simulator, especially the accuracy of the prediction, will gradually deviate from an actual result due to the lack of the key parameters. Secondly, using the simulation software with a severe accident calculation module, the accident development and related consequences can be calculated and predicted for the nuclear power station in the event of a severe accident. However, since severe accidents under real conditions often occur after a period of operation of the nuclear power station, the accuracy of the calculations of the simulator is still affected by the uncertainty of the above parameters. More importantly, the system calculation or prediction of the severe accidents is often not verified by a system-level test, which also leads to a possible distortion of its prediction results.

It should be noted that the above-mentioned “parameter uncertainty” and “severe accident prediction has not been actually verified” problems do not conflict with the accuracy and applicability of the calculation program and calculation method themselves. Even if the latter two are improved to the extremely perfect, the former problem still can not be completely solved, that is, when only using a high-precision calculation method and calculation software to carry out nuclear power station simulation and behavior prediction, due to the defects in input parameters,verification and correction, it will still lead to errors in the prediction results.

### SUMMARY OF INVENTION

### Technical Problem

The purpose of the present invention is to provide a high-precision high-fidelity real-time simulation and behavior prediction method and device for a nuclear power station so as to overcome the above-mentioned defects in the prior art.

The purpose of the present invention can be achieved through the following technical solutions:

A high-precision high-fidelity real-time simulation and behavior prediction method for a nuclear power station, wherein the method comprises the following steps:

(1) constructing a nuclear power station simulator and a physical nuclear power station based on the same design parameters;

(2) operating the nuclear power station simulator and the physical nuclear power station in parallel, and obtaining predicted parameters output from the nuclear power station simulator and operation parameters of the physical nuclear power station in real time;

(3) comparing the predicted parameters and the operation parameters representing the same physical quantity one by one, and correcting prediction models in the nuclear power station simulator and input parameters of the prediction models by adopting a large-scale concurrent-parallel parameter search and correction algorithm and an artificial intelligence-based mode recognition correction algorithm , and the predicted parameters infinitely approach the operation parameters until their differences reach specified precision, thereby completing the correction of the nuclear power station simulator;

(4) inputting an initial operation condition of a given physical nuclear power station system into the corrected nuclear power station simulator, and operating the nuclear power station simulator to obtain the predicted parameters, thereby completing a behavior prediction of the physical nuclear power station system.

Preferably, step (3) comprises two types of correction modes:

a first type of correction mode: keeping each of the prediction models used to predict all the predicted parameters in the nuclear power station simulator unchanged, and correcting the input parameters of the prediction models;

a second type of correction mode: correcting some of the prediction models in the nuclear power station simulator, and not correcting the remaining prediction models themselves, but correcting the input parameters of the remaining prediction models.

Preferably, the specific correction steps in step (3) comprises:

(31) in an initial correction cycle, performing simultaneously and concurrently the two types of correction modes, and performing concurrently a plurality of correction schemes in each type of correction mode, and operating in parallel the nuclear power station simulator according to the plurality of correction schemes to obtain the predicted parameters under each correction scheme;

(32) when a next correction cycle is reached, selecting respectively k groups of correction schemes with the top k positions in prediction accuracy in a previous correction cycle, and repeating the correction in step (31) for the k groups of correction schemes respectively;

(33) repeating step (32) and the predicted parameters infinitely approach the operation parameters until their differences reach the specified accuracy, and selecting an optimal correction scheme, thereby completing the correction of the nuclear power station simulator.

Preferably, the specific correction manner of the first type of correction mode is as follows:

firstly, obtaining a prediction parameter set X=(x1, x2, . . . , xn) currently output by the nuclear power station simulator, where xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), where EX is a set of the input parameters, and f is the prediction model, EX=(ex1, ex2, . . . , ext), ext represents a t-th input parameter, t=1, 2, . . . , t, t represents the total number of the predicted parameters; correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values;

then, dividing the set X into m subsets S1, S2, . . . Sm, and simultaneously and correspondingly dividing the set R into m subsets RS1, RS2, . . . , RSm, and comparing Sj and RSj one by one, wherein j=1, 2, . . . , m, wherein Sj corresponds to some of the input parameters in the input parameter set, said input parameters are recorded as EXSj, the parameter search and correction algorithm is used to correct the input parameter set EX, and all the prediction models are not corrected.

Preferably, a correction manner of the input parameter set EX is as follows: determining a correction value set EXSRaj of EXSj according to the error between Sj and RSj; and constituting a total set of input parameter correction values EXSRZ1=(EXSR0, EXSRa1, EXSRa2, . . . , EXSRam), where EXSR0 is a set of all input parameters in EX that do not correspond to any Sj; thereby completing the correction of the input parameters.

Preferably, the specific manner of performing concurrently a plurality of correction schemes in the first type of correction mode is as follows: taking a total set of input parameters correction values EXSRZ1 as one group of correction scheme, and randomly generating N groups of input parameter correction value expansion sets EXSRZ1′ based on the total set of input parameter correction values EXSRZ1 and the input parameter set EX to form N groups of correction schemes;

a constitution manner of EXSRZ1′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ1, selecting a group of random number sequence ROMt, then any correction value in the corresponding input parameter correction value expansion set EXSRZ1′ being exsrz1t=romt*exsrt, generating one expansion set of EXSRZ1′; and using N groups of random number sequences to perform the above operations so as to obtain N groups of input parameter correction value expansion sets EXSRZ1′.

Preferably, the specific correction manner of the second type of correction mode is as follows:

Firstly, obtaining a prediction parameter set X=(x1, x2, . . . , xn) currently output by the nuclear power station simulator, where xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), where EX is a set of the input parameters, and f is the prediction model, EX=(ex1, ex2, . . . , ext), ext represents a t-th input parameter, t=1, 2, . . . , t, t represents the total number of the predicted parameters; correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values;

Then, dividing the set X into m subsets S1, S2, . . . Sm, and simultaneously and correspondingly dividing the set R into m subsets RS1, RS2, . . . , RSm, and comparing Sj and RSj one by one, j=1, 2, . . . , m, if a subset Sj of which the contrast error of Sj and RSj remains unchanged or continuously increases in time stepping process for continuous multi-steps is denoted as Sj′, and the rest is denoted as Sj″, and Sj′ corresponds to some of the input parameters in the input parameter set, then denoting said some of the input parameters as EXSj′, denoting the input parameters corresponding to Sj″ as EXSj″, denoting the operation parameters corresponding to Sj′ as RSj′, and denoting the operation parameters corresponding to Sj″ as RSj″, and further, correcting the input parameters EXSj′ and the prediction models corresponding to Sj′ by the artificial intelligence-based mode recognition method, and correcting the input parameters EXSj″ corresponding to Sj″ by the parameter search and correction algorithm, while not correcting the prediction models corresponding to Sj″, thereby finally completing the correction of the input parameter set EX and the correction of some of the prediction models.

Preferably, the correction of the input parameter EXSj′ and the prediction models corresponding to Sj′ are specifically as follows: for Sj′, utilizing the artificial intelligence-based mode recognition method, with Sj′ infinitely approaching RSj′ as a target, and directly correcting EXSj′ to obtain a set of correction values EXSRbj′, at the same time, replacing the prediction models obtaining Sj′ with an artificial intelligence recognition model which directly obtains a prediction result according to EXSRbj′;

The correction of the input parameters EXSj″ corresponding to Sj″ is specifically as follows: for Sj″, determining the set of correction values Sj″ of EXSj″ according to the error between Sj″ and RSj″;

Finally, constituting the total set of input parameter correction values EXSRZ2=(EXSR0′, EXSRb1′, EXSRb2′, . . . , EXSRbp′, EXSRa1″, EXSRa2″, . . . , EXSRaq″), where EXSR0′ is a set of all input parameters not corresponding to any Sj in EX, p is a total number of input parameter subsets corrected by the artificial intelligence-based mode recognition method, q is a total number of input parameter subsets corrected by the parameter search and correction algorithm, p+q=m.

Preferably, the specific manner of performing concurrently a plurality of correction schemes in the second type of correction mode is as follows: taking a total set of input parameters correction values EXSRZ2 as one group of correction scheme, and randomly generating N groups of input parameter correction value expansion sets EXSRZ2′ based on the total set of input parameter correction values EXSRZ2 and the input parameter set EX to form N groups of correction schemes;

A constitution manner of EXSRZ2′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ2, selecting a group of random number sequence ROMt, then any correction value in the corresponding input parameter correction value expansion set EXSRZ2′ being exsrz2t=romt*exsrt, generating one expansion set EXSRZ2′, and using N groups of random number sequences to perform the above operations so as to obtain N groups of input parameter correction value expansion sets EXSRZ2′.

A high-precision high-fidelity real-time simulation and behavior prediction device for a nuclear power station, wherein the device comprises a memory and a processor, the memory is used to store a computer program, and the processor is used to, when the computer program is executed, realize the above methods.

Compared with the prior art, the present invention has the following advantages:

(1) The present invention innovatively makes the nuclear power station simulator operate in parallel with the physical nuclear power station, and inputs the operation parameters of the physical nuclear power station to the nuclear power station simulator in real time, and performs real-time comparison with the predicted parameters of the nuclear power station simulator. With the support of large-scale computer technology, large-scale concurrent/parallel parameter search and correction, and artificial intelligence-based mode recognition and correction algorithms, real-time adjustment of the prediction model of the power station simulator and the input parameters of the prediction model, so that the real-time predicted parameters of the simulation system will gradually approach the results of the operation parameters of the physical nuclear power station during long-term operation of the physical system, comparison between two systems and correction of the simulation system. This new simulation and calculation method greatly exceeds the operation effects of the existing simulator in terms of parameter authenticity and predicted reliability.

(2) The method of the present invention can be used for accurately predicting the behavior of the nuclear power station system and diagnosing failure causes under normal operation, overhaul and maintenance, and accident conditions, and provide a more reliable guarantee for the safe and economical operation of the nuclear power station.

### BRIEF DESCRIPTION OF DRAWINGS

FIG. 1 is a schematic diagram of the operation of a high-precision high-fidelity real-time simulation and behavior prediction method for a nuclear power station in the present invention.

### DESCRIPTION OF EMBODIMENTS

The present invention is described in detail below with reference to the accompanying drawings and specific embodiments. Note that the description of the following implementations is merely an example in nature, and the present invention is not intended to limit its application or its use, and the present invention is not limited to the following implementations.

### Embodiments

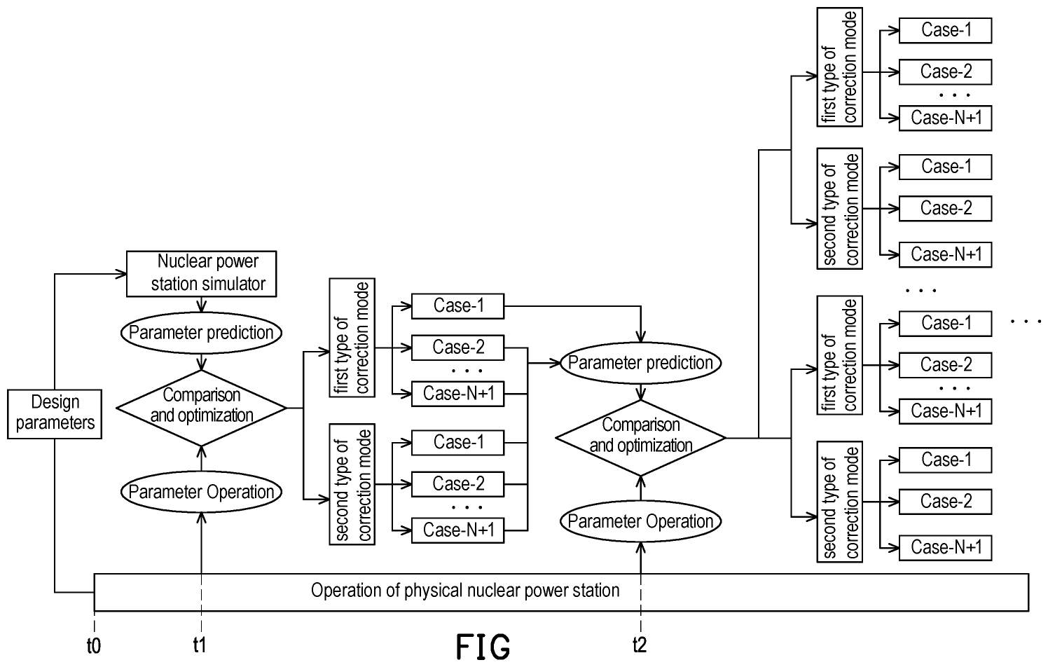

As shown in FIG. 1, provided is a high-precision high-fidelity real-time simulation and behavior prediction method for a nuclear power station, wherein the method comprises the following steps:

(1) constructing a nuclear power station simulator and a physical nuclear power station based on the same design parameters;

(2) operating the nuclear power station simulator and the physical nuclear power station in parallel, and obtaining predicted parameters output by the nuclear power station simulator and operation parameters of the physical nuclear power station in real time;

(3) comparing the predicted parameters and the operation parameters representing the same physical quantity one by one, and correcting prediction models in the nuclear power station simulator and input parameters of the prediction models by adopting a large-scale concurrent-parallel parameter search and correction algorithm and an artificial intelligence-based mode recognition correction algorithm, and the predicted parameters infinitely approach the operation parameters until their differences reach specified precision, thereby completing the correction of the nuclear power station simulator;

(4) inputting an initial operation condition of a given physical nuclear power station system into the corrected nuclear power station simulator, and operating the nuclear power station simulator to obtain the predicted parameters, thereby completing a behavior prediction of the physical nuclear power station system.

The predicted parameters output by the nuclear power station simulator comprise, but are not limited to, thermal hydraulics, nuclear physical parameters and design parameters such as circulation, materials, operation control and safety of the nuclear power station. The thermal hydraulic parameters are such as pressure, flow, inlet and outlet temperatures of primary and secondary circuits. The nuclear physical parameters are such as fuel enrichment, geometric dimensions of fuel rods, components and core components, fuel cycle period and component layout design, core structure materials, control rod materials and geometric structures, design parameters for start-up reactors, temperature and pressure for normal operation, as well as the pressure, temperature and materials of the safety equipment, the relevant threshold conditions of the safety equipment. Among them, some of the parameters can be directly measured by the physical nuclear power station (that is, the operation parameters of the physical nuclear power station described above), and some cannot be measured. The purpose of the correction in the present invention is to enable the predicted parameters output by the nuclear power station simulator and the actual state of the physical nuclear power station (comprising the above-mentioned measurable operation parameters of the physical nuclear power station and some unmeasurable operation parameters) to be kept parallel and consistent.

Step (3) comprises two types of correction modes:

a first type of correction mode: remaining each of the prediction models used to predict all the predicted parameters in the nuclear power station simulator unchanged, and correcting the input parameters of the prediction models;

a second type of correction mode: correcting some of the prediction models in the nuclear power station simulator, and not correcting the remaining prediction models themselves, but correcting the input parameters of the remaining prediction models.

The specific correction steps in step (3) comprises:

(31) in an initial correction cycle, performing simultaneously and concurrently the two types of correction modes, and performing concurrently a plurality of correction schemes in each type of correction mode, and operating in parallel the nuclear power station simulator according to the plurality of correction schemes to obtain the predicted parameters under the correction scheme;

(32) when a next correction cycle is reached, selecting respectively k groups of correction schemes with the top k positions in prediction accuracy in a previous correction cycle, and repeating the correction in step (31) for the k groups of correction schemes respectively;

(33) repeating step (32) and the predicted parameters infinitely approach the operation parameters until their differences reach the specified accuracy, and selecting an optimal correction scheme, thereby completing the correction of the nuclear power station simulator.

A specific correction manner of the first type of correction mode is as follows:

Firstly, obtaining a prediction parameter set X=(x1, x2, . . . , xn) currently output by the nuclear power station simulator, where xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), where EX is a set of the input parameters, and f is the prediction model, EX=(ex1, ex2, . . . , ext), ext represents a t-th input parameter, t=1, 2, . . . , t, t represents the total number of the predicted parameters.

Correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values, wherein the corresponding predicted parameters output by the nuclear power station simulator at the last moment can be selected as the given values. At the initial moment, the given values can be 0;

Then, dividing the set X into m subsets S1, S2, . . . Sm, and simultaneously and correspondingly dividing the set R into m subsets RS1, RS2, . . . , RSm, and comparing Sj and RSj one by one, wherein j=1, 2, . . . , m, wherein Sj corresponds to some of the input parameters in the input parameter set, said input parameters are recorded as EXSj, the parameter search and correction algorithm is used to correct the input parameter set EX, and all the prediction models are not corrected. Among them, the classification of the set X can be based on the traditional “phenomenon sorting table” method of nuclear engineering, starting from the system-equipment-phenomenon multi-level classification, and under the physical phenomenon, specific categories such as thermal hydraulics, nuclear physics, materials, control, operation, fuel cycle, safety, etc. are collected according to subject category.

Among them, a correction manner of the input parameter set EX is as follows: determining a correction value set EXSRaj of EXSj according to the error between Sj and RSj; and constituting a total set of input parameter correction values EXSRZ1=(EXSR0, EXSRa1, EXSRa2, . . . , EXSRam), where EXSR0 is a set of all input parameters in EX that do not correspond to any Sj; thereby completing the correction of the input parameters. The specific manner of performing concurrently a plurality of correction schemes in the first type of correction mode is as follows: taking the total set of input parameter correction values EXSRZ1 as one group of correction scheme, and randomly generating N groups of input parameter correction values expansion sets EXSRZ1′ based on the total set of input parameter correction values EXSRZ1 and the set of input parameters EX to form N groups of correction schemes; constitution manner of EXSRZ1′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ1, selecting a group of random number sequence ROMt, then any correction value in the corresponding input parameter correction value expansion set EXSRZ1′ being exsrz1t=romt*exsrt, generating one expansion set of EXSRZ1′; and using N groups of random number sequences to perform the above operations so as to obtain N groups of input parameter correction value expansion sets EXSRZ1′. Therefore, N+1 groups of correction schemes are concurrently performed.

The specific correction manner of the second type of correction mode is as follows:

Firstly, obtaining a prediction parameter set X=(x1, x2, . . . , xn) currently output by the nuclear power station simulator, where xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), where EX is a set of the input parameters, and f is the prediction model, EX=(ex1, ex2, . . . , ext), ext represents a t-th input parameter, t=1, 2, . . . , t, t represents the total number of the predicted parameters.

Correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values;

Then, dividing the set X into m subsets S1, S2, . . . Sm, and simultaneously and correspondingly dividing the set R into m subsets RS1, RS2, . . . , RSm, and comparing Sj and RSj one by one, j=1, 2, . . . , m, if a subset Sj of which the contrast error of Sj and RSj remains unchanged or continuously increases in time step of continuous multi-steps is denoted as Sj′, and the rest is denoted as Sj″, and Sj′ corresponds to some of the input parameters in the input parameter set, then denoting said some of the input parameters as EXSj′, denoting the input parameters corresponding to Sj″ as EXSj″, denoting the operation parameters corresponding to Sj′ as RSj′, and denoting the operation parameters corresponding to Sj″ as RSj″, and further, correcting the input parameters EXSj′ and the prediction models corresponding to Sj′ by the artificial intelligence-based mode recognition method, and correcting the input parameters EXSj″ corresponding to Sj″ by the parameter search and correction algorithm, while not correcting the prediction models corresponding to Sj″, thereby finally completing the correction of the input parameter set EX and the correction of some of the prediction models.

Sj′ The correction of corresponding input parameters EXSj′ and the prediction models are specifically as follows: for Sj′, utilizing the artificial intelligence-based mode recognition method, with Sj′ infinitely approaching, RSj′ as a target, and directly correcting EXSj′ to obtain a set of correction values EXSRbj′, at the same time, replacing the prediction models obtaining Sj′ with an artificial intelligence recognition model, which directly obtains a prediction result according to EXSRbj′; the correction of the input parameters EXSj″ corresponding to Sj″ is specifically as follows: for Sj″, determining the correction value set EXSRaj″ of EXSj″ according to the error between Sj″ and RSj″; finally, constituting the total set of input parameter correction values EXSRZ2=(EXSR0′, EXSRb1′, EXSRb2′, . . . , EXSRbp′, EXSRa1″, EXSRa2″, . . . , EXSRaq″), where EXSR0′ is a set of all input parameters not corresponding to any Sj in EX, p is the total number of input parameter subsets corrected by the artificial intelligence-based mode recognition method, q is the total number of input parameter subsets corrected by the parameter search and correction algorithm, p+q=m. The specific manner of performing concurrently a plurality of correction schemes in the second type of correction mode is as follows: taking the total set of input parameter correction values EXSRZ2 as one group of correction scheme, and randomly generating N groups of input parameter correction value expansion sets EXSRZ2′ based on the total set of input parameter correction values EXSRZ2 and the set of input parameters EX to form N groups of correction schemes; constitution manner of EXSRZ2′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ2, selecting a group of random number sequence ROMt, then any correction value in the corresponding input parameter correction value expansion set EXSRZ2′ being exsrz2t=romt*exsrt, generating one expansion set EXSRZ2′, and using N groups of random number sequences to perform the above operations so as to obtain N groups of input parameter correction value expansion sets EXSRZ2′. Therefore, N+1 groups of correction schemes are concurrently performed.

The specific implementation process of step (3) is as follows: referring to FIG. 1, at the start time t1 of a first correction cycle, comparing the predicted parameters and the operation parameters, so as to perform concurrently 2 types of correction modes, each of which has N+1 correction schemes, operating 2(N+1) correction schemes in parallel to obtain 2(N+1) groups of predicted parameters; when reaching the start time t2 of a second correction cycle, selecting the k groups of correction schemes with top k prediction accuracy in the previous correction cycle; under each group of the correction schemes, 2 types of correction modes are performed concurrently again. Each type of correction mode has N+1 correction schemes, so that 2k (N+1) correction schemes are operated in parallel in the second correction cycle to obtain 2k(N+1) groups of predicted parameters, and repeating the process until the prediction results reach the specified accuracy and the correction is stopped, and selecting the correction scheme with the best accuracy as an optimal scheme, which is used for the prediction of the nuclear power station simulator.

After completing the correction of the nuclear power station simulator in step (3), it also comprises the cause diagnosis and calculation of the specific behavior results of the nuclear power station, that is, using the combination of specific measurement parameters of the nuclear power station (such as the output parameters at the accident transient) as a target R, through the step in above (3), using the obtained optimized prediction models to determine the prediction parameter combination X that is closest to the target R, and the corresponding input parameter combination EX is the diagnosed power station state (cause of the accident).

A high-precision high-fidelity real-time simulation and behavior prediction device for a nuclear power station, wherein the device comprises a memory and a processor, the memory is used to store a computer program, and the processor is used to, when the computer program is executed, realize the above methods.

The foregoing implementations are only examples, and do not limit the scope of the present invention. These implementations can also be implemented in other various ways, and various omissions, substitutions, and changes can be made without departing from the scope of the technical idea of the present invention.

1. A high-precision high-fidelity real-time simulation and behavior prediction method for a nuclear power station, wherein the method comprises the following steps:
(1) constructing a nuclear power station simulator and a physical nuclear power station based on the same design parameters;
(2) operating the nuclear power station simulator and the physical nuclear power station in parallel, and obtaining predicted parameters outputted from the nuclear power station simulator and operation parameters of the physical nuclear power station in real time;
(3) comparing the predicted parameters and the operation parameters representing the same physical quantity one by one, and correcting prediction models in the nuclear power station simulator and input parameters of the prediction models by adopting a large-scale concurrent-parallel parameter search and correction algorithm and an artificial intelligence-based mode recognition correction algorithm, and the predicted parameters infinitely approach the operation parameters until their difference reach a specified precision, thereby completing the correction of the nuclear power station simulator;
(4) inputting an initial operation condition of a given physical nuclear power station system into the corrected nuclear power station simulator, and operating the nuclear power station simulator to obtain the predicted parameters, thereby completing a behavior prediction of the physical nuclear power station system.

2. The high-precision high-fidelity real-time simulation and behavior prediction method for a nuclear power station according to claim 1, wherein the step (3) comprises two types of correction modes:
a first type of correction mode: keeping each of the prediction models used to predict all the predicted parameters in the nuclear power station simulator unchanged, and correcting the input parameters of the prediction models;
a second type of correction mode: correcting some of the prediction models in the nuclear power station simulator, and not correcting the remaining prediction models themselves, but correcting the input parameters of the remaining prediction models.

3. The high-precision high-fidelity real-time simulation and behavior prediction method for a nuclear power station according to claim 2, wherein the specific correction steps in step (3) comprise:
(31) in an initial correction cycle, performing simultaneously and concurrently the two types of correction modes, and performing concurrently a plurality of correction schemes in each type of correction mode, and operating in parallel the nuclear power station simulator according to the plurality of correction schemes to obtain the predicted parameters under each correction scheme;
(32) when a next correction cycle is reached, selecting respectively k groups of correction schemes with the top k positions in prediction accuracy in a previous correction cycle, and repeating the correction in step (31) for the k groups of correction schemes respectively;
(33) repeating step (32) and the predicted parameters infinitely approach the operation parameters until their differences reach the specified accuracy, and selecting an optimal correction scheme, thereby completing the correction of the nuclear power station simulator.

4. The high-precision high-fidelity real-time simulation and behavior prediction method for a nuclear power station according to claim 3, wherein a specific correction manner of the first type of correction mode is as follows:
firstly, obtaining a prediction parameter set X=(x1, x2, . . . , xn) currently outputted by the nuclear power station simulator, wherein xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), wherein EX is a set of the input parameters, and f is the prediction model, EX=(ex1, ex2, ext), ext represents a t-th input parameter, t=1, 2, . . . , t, t represents the total number of the predicted parameters; correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values;
then, dividing the set X into m subsets S1, S2, Sm, and simultaneously and correspondingly dividing the set R into m subsets RS1, RS2, RSm, and comparing Sj and RSj one by one, wherein j=1, 2, . . . , m, wherein Sj corresponds to some of the input parameters in the input parameter set, said input parameters are recorded as EXSj, the parameter search and correction algorithm is used to correct the input parameter set EX, and all the prediction models are not corrected.

5. The high-precision high-fidelity real-time simulation and behavior prediction method for a nuclear power station according to claim 4, wherein a correction manner of the input parameter set EX is as follows: determining a correction value set EXSRaj of EXSj according to the error between Sj and RSj; and constituting a total set of input parameter correction values EXSRZ1=(EXSR0, EXSRa1, EXSRa2, . . . , EXSRam), wherein EXSR0 is a set of all input parameters in EX that do not correspond to any Sj; thereby completing the correction of the input parameters.

6. The high-precision high-fidelity real-time simulation and behavior prediction method for a nuclear power station according to claim 5, wherein the specific manner of performing concurrently a plurality of correction schemes in the first type of correction mode is as follows: taking a total set of input parameters correction values EXSRZ1 as one group of correction scheme, and randomly generating N groups of input parameter correction value expansion sets EXSRZ1′ based on the total set of input parameter correction values EXSRZ1 and the input parameter set EX to form N groups of correction schemes;
a constitution manner of EXSRZ1′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ1, selecting a group of random number sequence ROMt, then any correction value in the corresponding input parameter correction value expansion set EXSRZ1′ being exsrz1t=romt*exsrt, generating one expansion set EXSRZ1′; and using N groups of random number sequences to perform the above operations so as to obtain N groups of input parameter correction value expansion sets EXSRZ1′.

7. The high-precision high-fidelity real-time simulation and behavior prediction method for a nuclear power station according to claim 3, wherein the specific correction mode of the second type of correction mode is as follows:
firstly, obtaining a prediction parameter set X=(x1, x2, . . . , xn) currently outputted by the nuclear power station simulator, where xi represents an i-th predicted parameter, i=1, 2, . . . , n, n represents a total number of the predicted parameters, wherein the first p predicted parameters are physical quantities that can be directly obtained by the physical nuclear power station, and the remaining n-p predicted parameters are physical quantities that cannot be directly obtained by the physical nuclear power station, X=f(EX), where EX is a set of the input parameters, and f is the prediction model, EX=(ex1, ex2, ext), ext represents a t-th input parameter, t=1, 2, . . . , t, t represents the total number of the predicted parameters; correspondingly, obtaining an operation parameter set R=(r1, r2, . . . , rn) of the physical nuclear power station, wherein the physical quantities represented by all elements in the set R and the set X are in one-to-one correspondence, the first p operation parameters are the directly obtained operation parameters of the physical nuclear power station, and the rest are given values;
then, dividing the set X into m subsets S1, S2, . . . , Sm, and simultaneously and correspondingly dividing the set R into m subsets RS1, RS2, . . . , RSm, and comparing Sj and RSj one by one, j=1, 2, . . . , m, if a subset Sj of which the contrast error of Sj and RSj remains unchanged or continuously increases in time step of continuous multi-steps is denoted as Sj′, and the rest is denoted as Sj″, and Sj′ corresponds to some of the input parameters in the input parameter set, then denoting said some of the input parameters as EXSj′, denoting the input parameters corresponding to Sj″ as EXSj″, denoting the operation parameters corresponding to Sj′ as RSj′, and denoting the operation parameters corresponding to Sj″ as RSj″, and further, correcting the input parameters EXSj′ and the prediction models corresponding to Sj′ by the artificial intelligence-based mode recognition method, and correcting the input parameters EXSj″ corresponding to Sj″ by the parameter search and correction algorithm, while not correcting the prediction models corresponding to Sj″, thereby finally completing the correction of the input parameter set EX and the correction of some of the prediction models.

8. The high-precision high-fidelity real-time simulation and behavior prediction method for a nuclear power station according to claim 7, wherein,
the correction of the input parameter EXSj′ and the prediction models corresponding to Sj′ are specifically as follows: for Sj′, utilizing the artificial intelligence-based mode recognition method, Sj′ infinitely approaching RSj′, as a target, and directly correcting EXSj′ to obtain a set of correction values EXSRbj′, at the same time, replacing the prediction models obtaining Sj′ with an artificial intelligence recognition model which directly obtains a prediction result according to EXSRbj′;
the correction of the input parameters EXSj″ corresponding to Sj″ is specifically as follows: for Sj″, determining the set of correction values EXSRaj″ of EXSj″ according to the error between Sj″ and RSj″;
finally, constituting the total set of input parameter correction values EXSRZ2=(EXSR0′, EXSRb1′, EXSRb2′, . . . , EXSRbp′, EXSRa1″, EXSRa2″, . . . , EXSRaq″), where EXSR0′ is a set of all input parameters not corresponding to any Sj in EX, p is a total number of input parameter subsets corrected by the artificial intelligence-based mode recognition method, q is a total number of input parameter subsets corrected by the parameter search and correction algorithm, p+q=m.

9. The high-precision high-fidelity real-time simulation and behavior prediction method for a nuclear power station according to claim 8, wherein the specific manner of performing concurrently a plurality of correction schemes in the second type of correction mode is as follows: taking a total set of input parameters correction values EXSRZ2 as one group of correction scheme, and randomly generating N groups of input parameter correction value expansion sets EXSRZ2′ based on the total set of input parameter correction values EXSRZ2 and the input parameter set EX to form N groups of correction schemes;
a constitution manner of EXSRZ2′ is as follows: generating N groups of random number sequences ROMn, wherein each random number sequence contains t random numbers romt, the random variation range of romt is (0, z), z is an over-correction coefficient, and the value of z is 1˜2, letting the input parameter correction values exsrt∈EXSRZ2, selecting a group of random number sequence ROMt, then any correction value in the corresponding input parameter correction value expansion set EXSRZ2′ being exsrz2t=romt*exsrt, generating one expansion set EXSRZ2′, and using N groups of random number sequences to perform the above operations so as to obtain N groups of input parameter correction value expansion sets EXSRZ2′.

10. A high-precision high-fidelity real-time simulation and behavior prediction device for a nuclear power station, wherein the device comprises a memory and a processor, the memory is used to store a computer program, and the processor is used to, when the computer program is executed, realize the method according to claim 1.

11. A high-precision high-fidelity real-time simulation and behavior prediction device for a nuclear power station, wherein the device comprises a memory and a processor, the memory is used to store a computer program, and the processor is used to, when the computer program is executed, realize the method according to claim 2.

12. A high-precision high-fidelity real-time simulation and behavior prediction device for a nuclear power station, wherein the device comprises a memory and a processor, the memory is used to store a computer program, and the processor is used to, when the computer program is executed, realize the method according to claim 3.

13. A high-precision high-fidelity real-time simulation and behavior prediction device for a nuclear power station, wherein the device comprises a memory and a processor, the memory is used to store a computer program, and the processor is used to, when the computer program is executed, realize the method according to claim 4.

14. A high-precision high-fidelity real-time simulation and behavior prediction device for a nuclear power station, wherein the device comprises a memory and a processor, the memory is used to store a computer program, and the processor is used to, when the computer program is executed, realize the method according to claim 5.

15. A high-precision high-fidelity real-time simulation and behavior prediction device for a nuclear power station, wherein the device comprises a memory and a processor, the memory is used to store a computer program, and the processor is used to, when the computer program is executed, realize the method according to claim 6.

16. A high-precision high-fidelity real-time simulation and behavior prediction device for a nuclear power station, wherein the device comprises a memory and a processor, the memory is used to store a computer program, and the processor is used to, when the computer program is executed, realize the method according to claim 7.

17. A high-precision high-fidelity real-time simulation and behavior prediction device for a nuclear power station, wherein the device comprises a memory and a processor, the memory is used to store a computer program, and the processor is used to, when the computer program is executed, realize the method according to claim 8.

18. A high-precision high-fidelity real-time simulation and behavior prediction device for a nuclear power station, wherein the device comprises a memory and a processor, the memory is used to store a computer program, and the processor is used to, when the computer program is executed, realize the method according to claim 9.
